(19) United States
(12) Patent Application Publication
(10) Pub. No.: US 2005/0230443 A1
(43) Pub. Date: Oct. 20, 2005

(54) Backpack for tractor seat - cargo carrying

(76) Inventor: Todd Phillip Bredeson, Deforest, WI (US)

Correspondence Address: TODD PHILLIP BREDESON, 4341 HAWK TRAIL, DEFOREST, WI, 53532, US

(21) Appl. No.: 10/828,871

(22) Filed: Apr. 20, 2004

(51) Int. Cl. B60R 7/00; B60R 9/00; B60R 11/00

(52) U.S. Cl. 224/275; 224/410

(57) ABSTRACT

Comprised of a pliable material main body having attached cargo pockets of pliable material and cargo tie straps. The cargo tie straps are a combination of pliable material and hook and loop fasteners. The main body incorporates two sets of adjustable fastening straps that allow it to be cinched to the back of a seat. The first of two cinch straps is made of pliable material, a buckle loop and hook and loop fasteners. The second of two cinch straps is made of elastic strips and hook and loop fasteners.

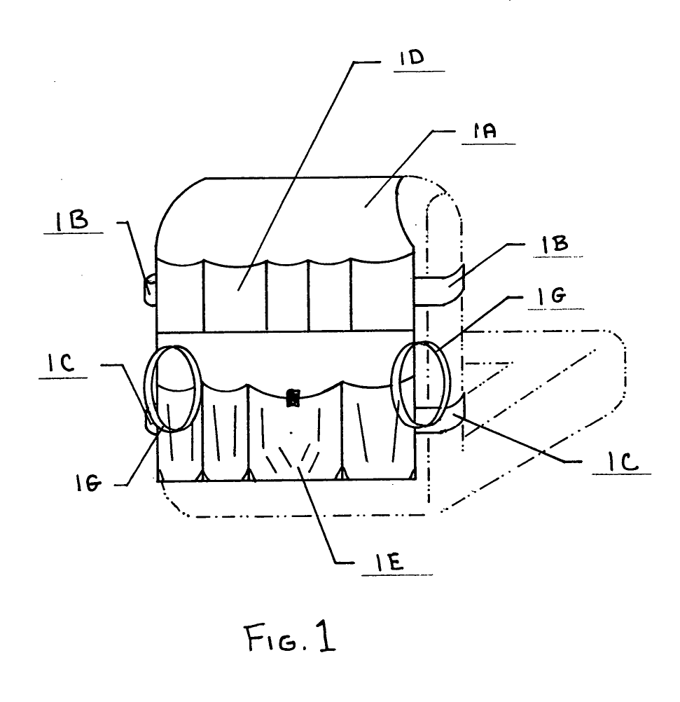

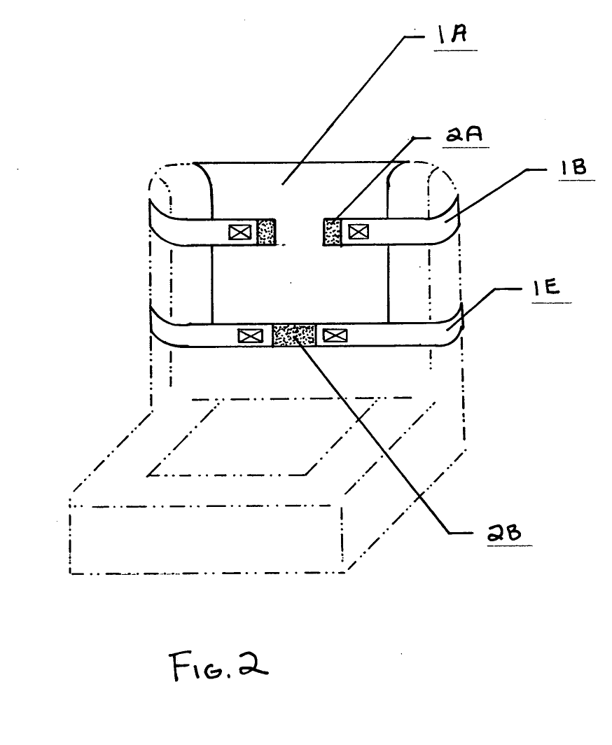

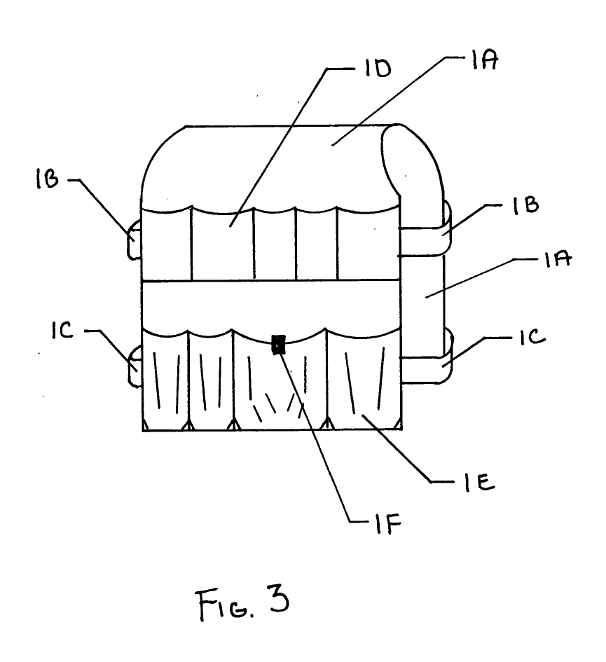

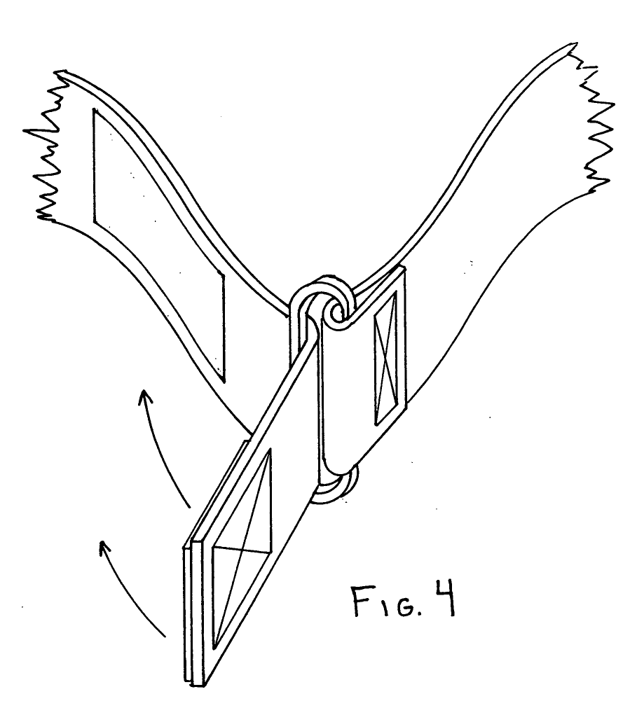

### STATEMENT REGARDING FEDERALLY SPONSORED RESEARCH OR DEVELOPMENT

“Not Applicable”

### REFERENCE TO SEQUENCE LISTING, A TABLE, OR A COMPUTOR PROGRAM LISTING COMPACT DISC APPENDIX

“Not Applicable”

### BACKGROUND OF INVENTION

1. Field of Invention

This invention relates to a device used to hold and carry hand tools and other items on the seat back of a garden tractor or similar vehicle.

2. Background of Invention

It is not uncommon to require the need for tools and other items while operating lawn mowing, garden or full size tractors and similar vehicles. Storing tools and items in a space on these vehicles not made for said purpose may result in loss of tools or damage to the vehicle. An alternative solution might be to attach some form of box or bucket for storing and carrying tools and other small items. Using an attached bucket or box for storage on these types of vehicles may impede proper operation resulting in undesirable results or a safety hazard.

### BACKGROUND OF INVENTION—OBJECTS AND ADVANTAGES

The “Back Pack for Tractor Seat—Cargo Carrying” offers a variety of advantages over the fore mentioned methods of tool and item storage and carrying on a tractor or similar vehicle. These advantages are:
(a) the pockets and straps provide a way to securely store and organize hand tools or other items;
(b) the storage pockets and straps dictate that tools and items stored are on the back of the vehicle seat keeping the stored items out of the way of the operator;
(c) the adjustable cargo straps allow larger items that won't fit it the provided pockets to be tied to the “Back Pack for Tractor Seat”;
(d) the middle pocket on the lower group of pockets has a closure hook and loop system that allows a ball of string or twin to be stored and dispensed without removing the ball;
(e) the adjustable securing straps allow the “Back Pack for Tractor Seat” to be fit to a variety of vehicle seat sizes;

### BREIF SUMMARY OF INVENTION

The “Back Pack for Tractor Seat—Cargo Carrying”, offers the user a simple way to securely carry and store tools and other items on a tractor type vehicle while at the same time keeping the stored items out of the way of the vehicle operator and preventing damage to the vehicle. The adjustment straps allow the user to fit the invention to many seat back sizes by adjusting the strap lengths. This feature allows the invention to be used on a variety of different vehicles.

### DETAILED DESCRIPTION

The main body (1A) is made of a pliable material that allows flexing so that the main body can be folded over the back of a seat. Fastened to the main body are cinch straps (1B and 1C) that are used to secure the main body to a seat back. The first of two types of cinch straps (1C) are constructed of an elastic strip fastened to a point on the main body having one of two parts of a hook and loop fastening system attached to the loose end of said strap which mates to the second part of the hook and loop fastener which is attached to the opposite side (2B) of the main body. The second type of strap (2A) consists of two parts, the first part is constructed of a pliant strip of material attached to one point on the main body having one of a two part hook and loop fastening system attached to the loose end. The second part consists of a strip of pliant material folded to capture a bucket loop and attached to an opposing point on the main body so as to line up with the first part attachment point when the main body is folded. The first part of the strap is then fed through the bucket loop of the second part (4/4) folded back on its self and mated to the second part of the hook and loop fastener located on the main body (2A).

Rows of cargo pockets are constructed of pliant material and attached to the face of the main body. The upper cargo pockets (1D) are attached flat to accommodate small tools and items. The lower cargo pockets (1E) are pleated to offer expansion for items needing larger area of storage. One of the lower cargo pockets has a hook and loop fastener located on the edge of the pocket near the opening (1F). This fastener allows for said pocket to be partially sealed while leaving an intentional gap opening at the mouth of the pocket to allow string or twine to pass through allowing dispensing without removing the ball from the pocket.

### Additional Cargo may be Attached to this Device by Means of Tie Straps (1G)

A strip of pliant material with a buckle loop attached to one end and one half of a hook and loop fastener to the other is attached to the main body at a point between the upper and lower cargo pockets near the edge of the main body. Said strip also has the mating half attached to the back side of said strip so when the strip is fed through the buckle loop and folded back it secures itself to its hook and loop mate.

From my description above a number of advantages become evident:
a) The “Backpack for Tractor seat—Cargo Carrying” will stow and carry a variety of tools and items of many shapes and sizes keeping these items safely stowed and easily accessible.
b) Due to the adjustable nature of the cinch straps (1B and 1C) this device is not limited to one size of seat back.
c) The elastic cinch straps (1C) will flex to conform to the back of the person seated in a seat using this device.
d) The cargo tie straps (1G) provide a means to attached larger items that will not fit in the cargo pockets.
e) A variety of pocket sizes securely hold items and tools ranging in size from small to large.

Properly installed on a seat back this device offers safe and convenient storage for tools while working in the yard or at a job site. Although this device may take different form or be constructed of different materials its usage is always the same, to carry items on a seat back.

1. A seat-back cincturing, item stowage device comprising:
(a) main-body of pliable material equipped with and adjustable fastening system and,
(b) pockets of pliable material,
(c) a plurality of said pockets attached to said main-body and,
(d) straps of pliant material equipped with fasteners,
(e) said straps attached to said main-body,
whereby said elements form a cincturing device, whereby said device captures said seat-back, whereby locating said pockets and straps in a fashion that allows stowage of items.
